(19) United States
(12) Patent Application Publication
(10) Pub. No.: US 2011/0231752 A1
(43) Pub. Date: Sep. 22, 2011

(54) E-BOOK READ APPARATUS AND OPERATION METHOD THEREOF

(75) Inventors: Gary Kung, Santa Ana, CA (US); Ping-Shun Zeung, Santa Ana, CA (US)

(73) Assignee: I/O INTERCONNECT, LTD., Santa Ana, CA (US)

(21) Appl. No.: 13/025,705

(22) Filed: Feb. 11, 2011

Related U.S. Application Data
(60) Provisional application No. 61/315,416, filed on Mar. 19, 2010.

(51) Int. Cl. G06F 17/00

(52) U.S. Cl. 715/243

(57) ABSTRACT

An e-book read apparatus has a screen, a storage unit, a processing module and a layout tool. The storage saves at least one e-book having a plurality of chapters and sections, and pages. The processing is coupled to the storage unit for showing the e-book on the screen for responsing a read request. In addition, the layout is installed in the processing module or the storage unit for re-typeset the e-book for responsing a re-layout request.

### CROSS-REFERENCE TO RELATED APPLICATION

This application claims the priority benefit of U.S. application Ser. No. 61/315416, filed on Mar. 19, 2010. The entirety of the above-mentioned patent application is incorporated herein by reference and made a part of this specification.

### BACKGROUND

1. Technical Field

The present invention generally relates to an e-book and particularly, to an operation method for index information of the e-book.

2. Description of the Related Art

Along with the development of the technical and the popularization of network information, each kind of language as well as the image data also grows day by day. So that the conventional read mode has a great influence and impact. If the huge quantity image data is used conventional printing way dissemination, its volume and quantity are quite astonishing. It is inconvenient on carrying, reading or preserving, and expensive on paying the ecology cost. Therefore, with the digital time coming, developing the e-book having such characters which comprises carrying many volumes of publication documents once time, the content being searchable, downloading from the network directly, obtaining the book easily, decreasing great cost of printing and mailing is necessary.

Thus, many kinds of relative electric read apparatuses are also developed, so as to assist the user processing information without time and space limitations. These electric read apparatuses have several characters such like that the size is appropriate as a normal book, conforms the user's read habit, carries easily, has ability for saving great volume books as a small library, has high resolution, has a battery with long using time, displays image clearly, allows user to read under any light source, downloads articles with digital copyright form internet or computer, has perfect digital copyright security system, and guarantees the copyright being not pirated infringement.

Although many kinds of electric read apparatuses can be chosen, a big problem of current electric read apparatuses is whether or not the operation means conforming user's habit so as to let user operates convenient.

### BRIEF SUMMARY

Therefore, the present invention provides an e-book read apparatus for a user to read the e-book by a means conforming the user's requirement.

In addition, the present invention provides a plurality of operation methods for an e-book, having ability for a user to read the e-book more convenient.

An e-book read apparatus provided by the present invention has a screen, a storage unit, a processing module, and a layout tool. The storage unit saves at least one e-book having a plurality of chapters and sections, and pages. The processing is coupled to the storage unit for showing the e-book on the screen for responsing a read request. In addition, the layout is installed in the processing module or the storage unit for re-typeset the e-book for responsing a re-layout request.

From another viewpoint, an operation method for an e-book provided by the present invention comprises displaying the e-book having a plurality of chapters and sections for responsing a read request. Furthermore, the chapters and the sections with a keyword are laid in front of other chapters and sections without keyword for responsing a re-layout request for re-typesetting the e-book.

From another viewpoint, another one operation method for an e-book provided by the present invention comprises displaying the e-book having a plurality of pages for responsing a read request. Furthermore, the present invention allows a user to mark a selection block in one of pages, and shows the selection block and the page read currently for responsing a comparison request.

From another viewpoint, another one operation method for an e-book further provided by the present invention comprises displaying the e-book having a plurality of chapters and sections, and pages for responsing a read request. The chapters and the sections with a keyword are laid in front of other chapters and sections without keyword for responsing a re-layout request for re-typesetting the e-book. Furthermore, the present invention allows a user to mark a selection block in one of pages, and shows the selection block and the page read currently for responsing a comparison request.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system block diagram of an e-book read apparatus according to a preferred embodiment of the present invention.

FIG. 2 shows a diagram of a content image of an e-book.

FIG. 3 shows a diagram the re-typeset content of the e-book according to a preferred embodiment of the present invention.

FIGS. 4A and 4B shows a diagram of one page of an e-book.

FIG. 5 shows a diagram of a selection block in a page of an e-book according to a preferred embodiment of the present invention.

FIG. 6 shows a diagram of showing both of a selection block and the page read currently according to a preferred embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

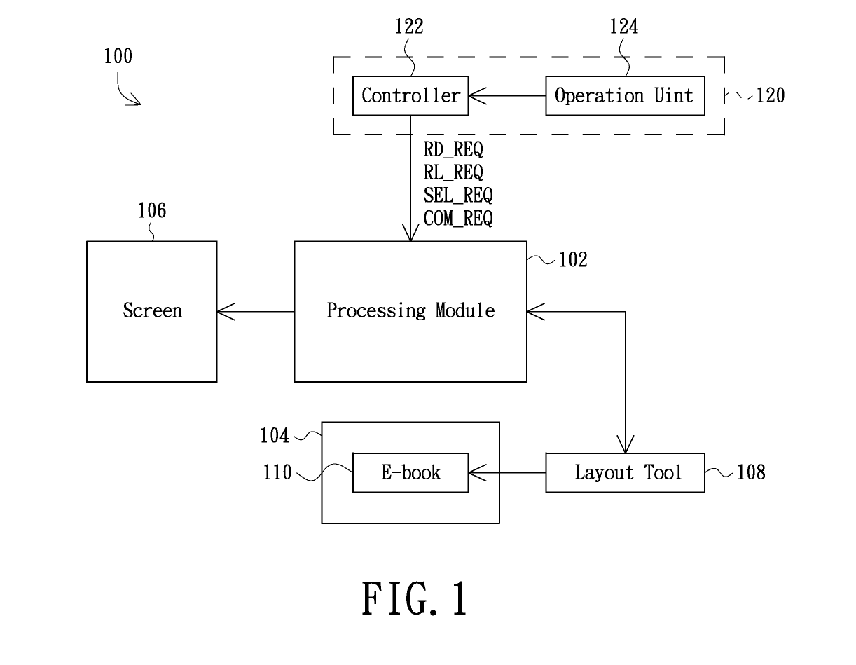

FIG. 1 shows a system block diagram of an e-book read apparatus according to a preferred embodiment of the present invention. Referring the FIG. 1, the read apparatus 100 provided by the embodiment comprises a processing module 102 coupled to a storage unit 104 and screen 106. In addition, the processing module 102 exchange massage with a layout tool 108. In the present embodiment, the storage unit 104 saves at least one e-book 104. Wherein the e-book 104 has a plurality of chapters and sections, and pages.

The storage unit 104 is probably a memory card, an optical storage media or a external storage apparatus. In other embodiments, the storage unit 104 is probably a hard disk. Furthermore, the layout tool 108 is implemented by application software. In further case, the layout tool 108 is installed in the processing module 102 or storage unit 104.

In some embodiments, the read apparatus 104 further comprises a operation module 120 coupled the processing module 102. The operation module 120 has a controller 122 and at least one operation unit 124. The operation unit 124, for example, is a real press key, trace ball, touch control board, joy stick etc., wherein the operation unit 124 is coupled to the controller 122. When a user operates the operation unit 124, the controller 122 outputs corresponding control signal to the processing module 102. For example, when the user operates the operation module 120 to send a read request RD_REQ, the processing module 102 obtains the e-book 110 from the storage unit 104, and displays the e-book 110 on the screen 106. In addition, the user can further operate the operation module 120 to control the e-book 110 to read.

In some embodiments, the screen 106 is probably a touch control screen. In other embodiments, the screen 106 is further a bi-stable screen such an electrophoretic screen.

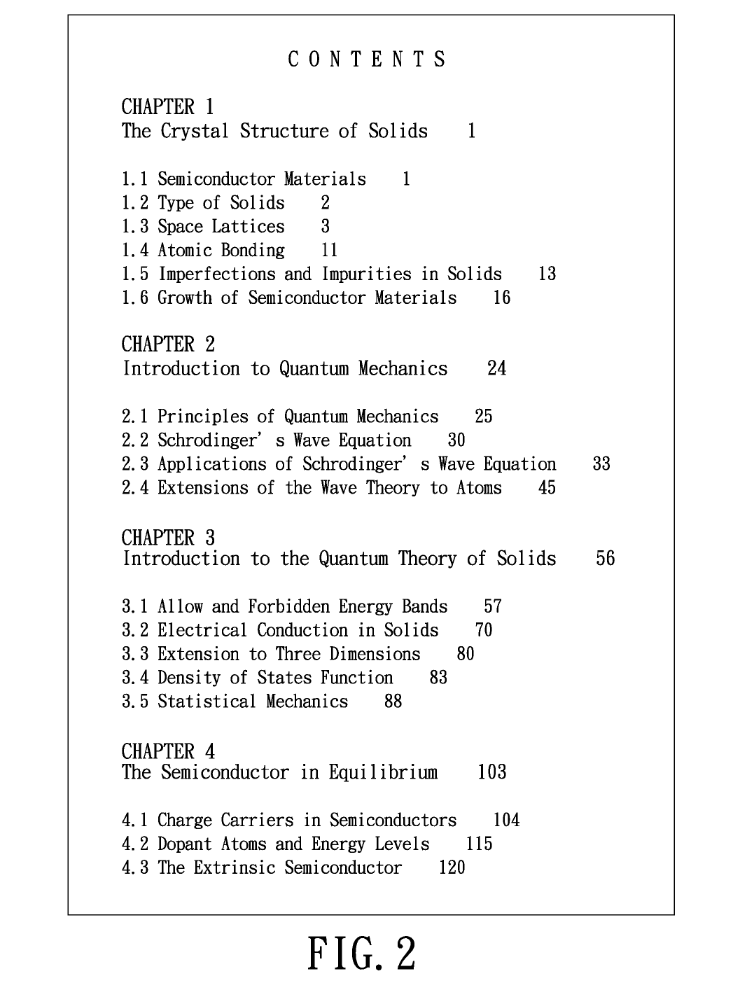

FIG. 2 shows a diagram of a content image of an e-book. Referring FIGS. 1 and 2, it is well known that normal content of an e-book is arranged according to the sequences of chapters and sections. In particularly, in the present embodiment, when the processing module 102 receives a re-layout request RL_REQ, the re-layout request RL_REQ is sent to the layout tool 108. Then, the layout tool 108 requests a user to input a keyword. Therefore, the layout tool 108 lays the chapters and sections with the keyword in front of other chapters and sections without the keyword for re-typesetting the e-book 110.

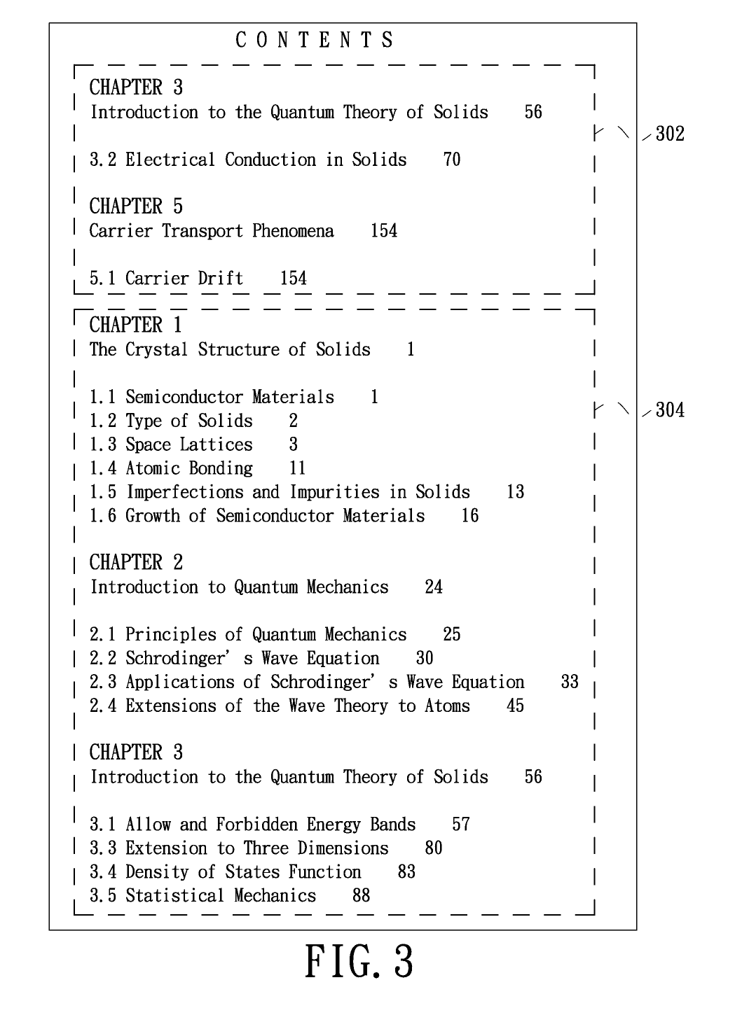

FIG. 3 shows a diagram the re-typeset content of the e-book according to a preferred embodiment of the present invention. Referring to FIGS. 1 and 3, in present embodiment, when the user inputs a keyword like “drift current”, the layout tool 108 searches the chapters and sections with the keyword “drift current” in the e-book 110, and obtains a search result. Then, chapters and sections with the keyword “drift current”, like the area around the dotted line 302, are laid in front of other chapters and sections without the keyword “drift current” such like the area around the dotted line 304 and arranged according to the sequences the sequences of the chapters and sections. In other embodiments, even the pages of the e-book 110 can be re-typeset corresponding to the adjustment of the content.

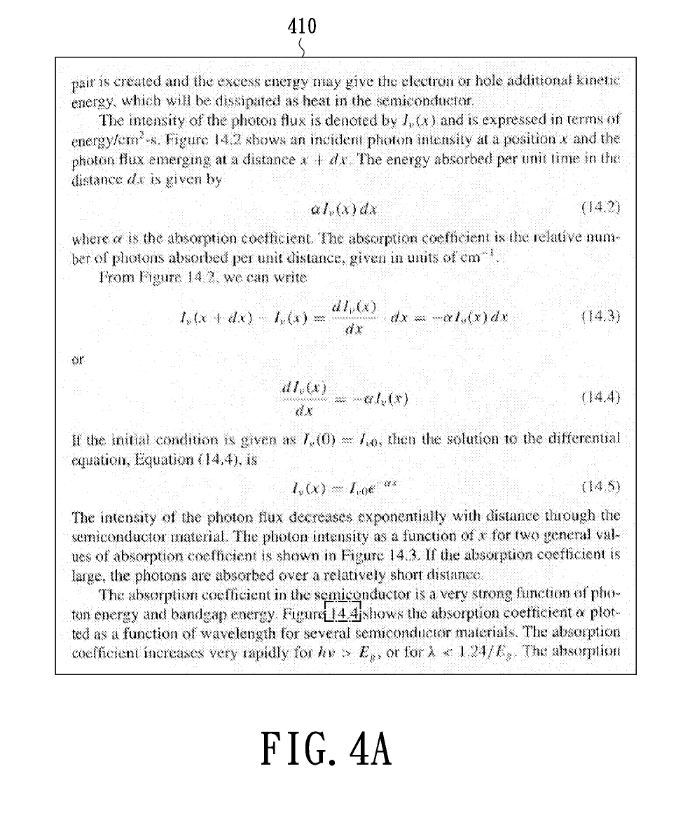

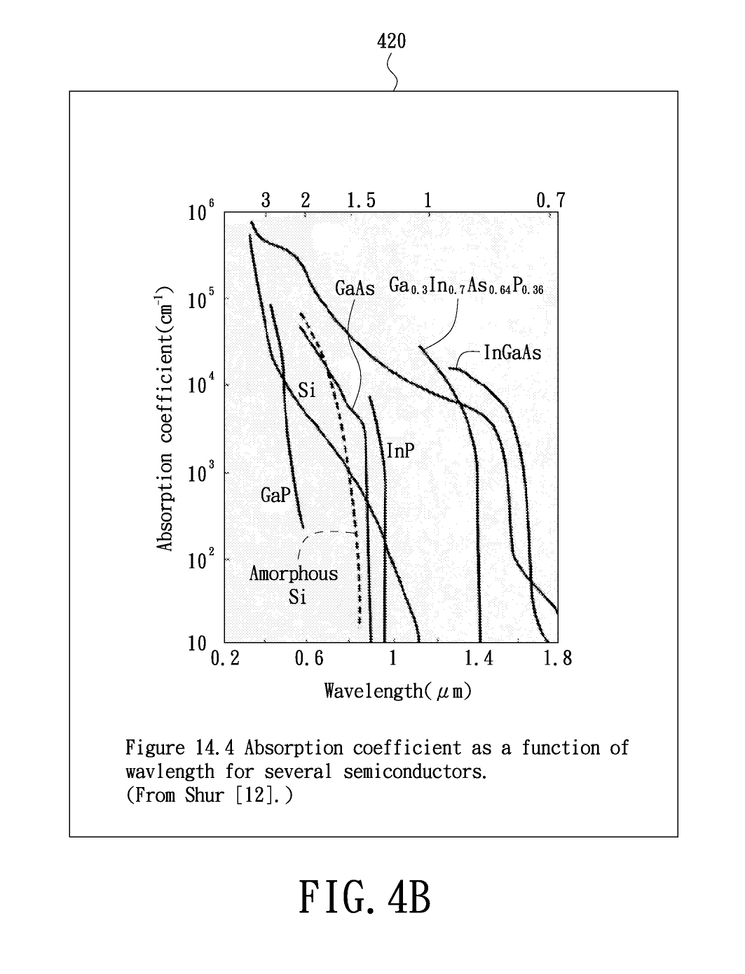

Referring to FIG. 1 continually, in another situation, when a user read one of the pages of the e-book 110 and needs to refers description or diagram in another page, such like FIG. 4A. When a user read the page 410 in FIG. 4A, the FIG. 14.4 which is around by dotted line is needed to refer. However, the FIG. 14.4 is not in the page 410 in FIG. 4A, but in the page 420 in FIG. 4B. In conventional operation, user need switch the pages in FIGS. 4A and 4B continually, so as to refer mutually.

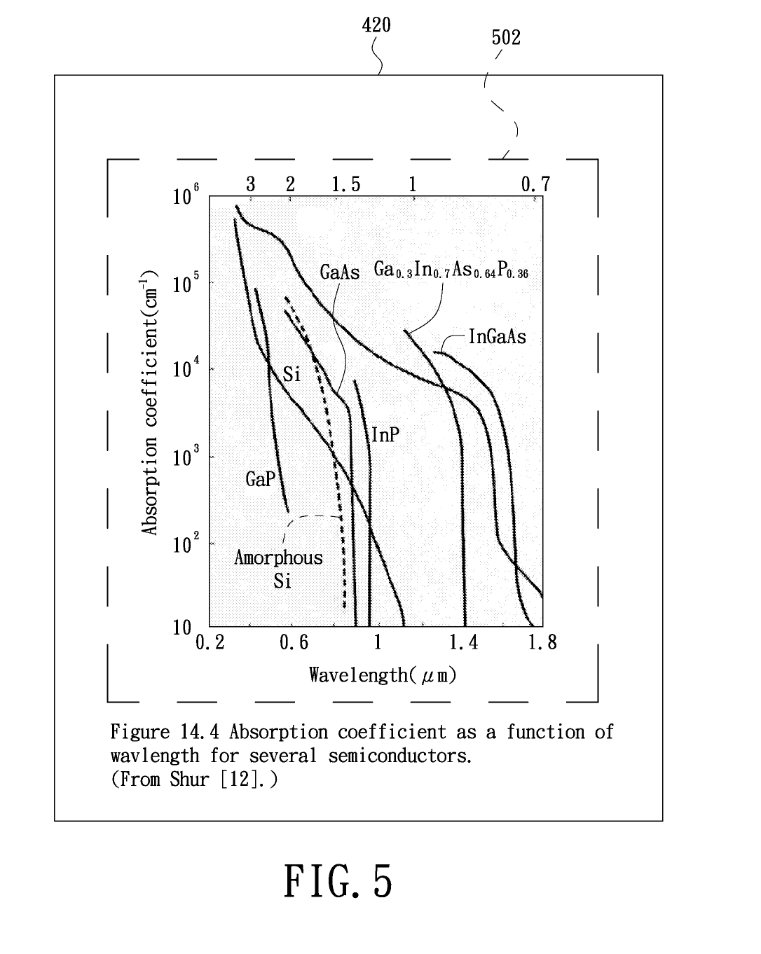

However, in the present embodiment, the user can operate the operation module 102 to send a selection request SEL_REQ. Meanwhile, the processing module 102 sends the selection request SEL_REQ to the layout tool 108, so as to allow the user to choose one of pages of e-book 110 and to mark a selection block. For example, the user can select the pages 420, and then use a selective tool (not shown) provided by the layout tool 108 to mark the FIG. 14.4 in page 420 for generate a selection block 502 in page 420 shown in FIG. 5.

Then, the user can operate the operation module 102 to send a comparison request COM_REQ. Similarly, the processing module 102 send the comparison request COM_REQ to the layout tool 108. Then, the layout tool 108 shows both of the page read currently such like page 410 and selection block such like selection block 502 on screen 106.

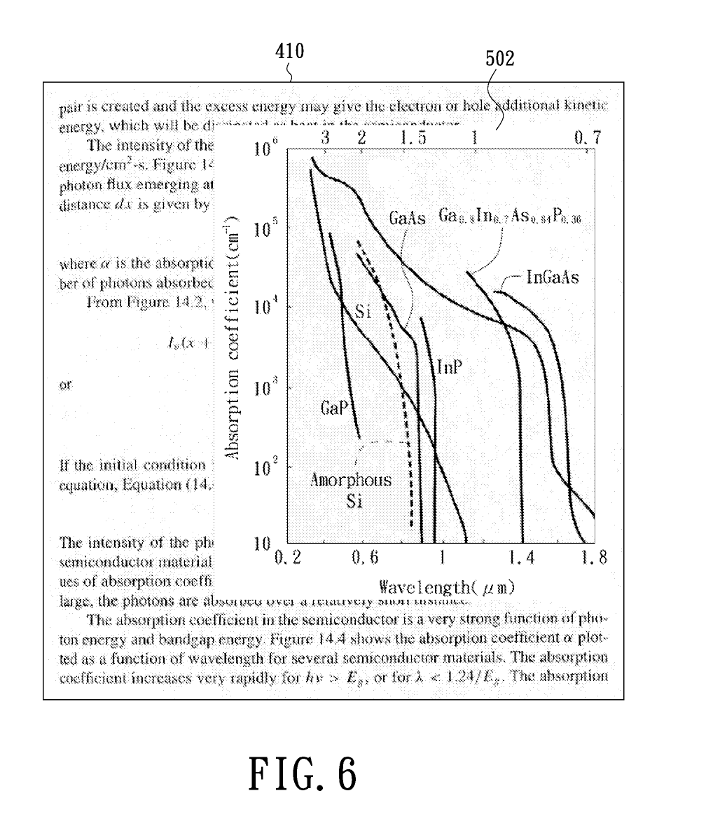

FIG. 6 shows a diagram of showing both of a selection block and the page read currently according to one preferred embodiment of the present invention. Referring to FIGS. 1 and 6, in the present embodiment, the layout tool 108 makes the selection block 502 to float on the page 410 read by the user currently. Therefore, the user can directly read page 410 and refer the selection 502 without switching the pages. In other embodiments, the selection block 502 and page 410 read by the user currently are shown side by side on the screen 106 on horizontal direction.

In some embodiments the selection block 502 floated on the page 410 read by the user currently further move to any position on the page 410 according to a move operation which is probably an instruct sand through the operation module 120. Therefore, it is convenient for the user to compare and read.

In summary, the present invention allows a user to input needed keyword, and re-arranges the sequences the chapters and sections according to the keyword. Thus, the user can find needed information fast. Furthermore, the present invention further has ability of showing both of the selection block marked by the user and the page read currently, so that the user can read e-book more convenient.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An e-book read apparatus, comprising:
a storage unit, saving at least one e-book having a plurality of chapters and sections, and pages;
a processing module, coupled to the storage unit for obtaining the e-book for responsing a read request;
a screen, coupled to the processing module for displaying the e-book; and
a layout tool, installed to one of the storage unit and the processing module for re-typesetting the e-book for responsing a re-layout request.

2. The e-book read apparatus as claimed in claim 1, further comprising a operation module has at least one operation unit.

3. The e-book read apparatus as claimed in claim 1, wherein the storage unit is a hard disk.

4. An operation method for an e-book, which has a plurality of chapters and sections, and the operation method comprises:
displaying the e-book for responsing a read request; and
laying the chapters and sections with a key word in front of the chapters and sections without the keyword for responsing a re-layout request, so as to re-typeset the e-book.

5. The operation method as claimed in claim 4, wherein the steps of re-layout the e-book comprises:
requesting a user to input the keyword;
searching the e-book to find the chapters and sections with the keyword; and
arranging the sequences of the chapters and sections with the keyword, and the sequences of the chapters and sections without the keyword according to the sequence of each of the chapters and sections.

6. An operation method for an e-book, which has a plurality of pages, and the operation method comprises:
displaying the e-book for reponsing a read request;
allowing a user to mark a selection block in the content of one of the pages for responsing a selection request; and
showing both of the selection block and the page read currently for reponsing a comparison request.

7. The operation method as claimed in claim 6, wherein the selection block is a diagram.

8. The operation method as claimed in claim 6, wherein the step of showing both of the selection block and the page read currently comprises making the selection block to float on the page read currently.

9. The operation method as claimed in claim 8, the floated selection block moved to any position of the page read currently according to a move operation.

10. The operation method as claimed in claim 6, wherein the step of showing both of the selection block and the page read currently comprises showing the selection block and the page read currently side by side in a display screen.

11. An operation method for an e-book, which has a plurality of chapters and sections, and pages, and the operation method comprises:
displaying the e-book for reponsing a read request;
laying the chapters and sections in front of the chapters and sections without the keyword for reponsing a re-layout request, so as to re-typeset the e-book;
allowing a user to mark a selection block in the content of one of the pages for responsing a selection request; and
showing both of the selection block and the page read currently for reponsing a comparison request.
